(19) United States
(12) Patent Application Publication
(10) Pub. No.: US 2019/0317631 A1
(43) Pub. Date: Oct. 17, 2019

(54) METAL MESH TOUCH DISPLAY STRUCTURE AND MANUFACTURING METHOD THEREOF

(71) Applicant: Wuhan China Star Optoelectronics Semiconductor Display Technology Co., Ltd., Wuhan (CN)

(72) Inventors: Xiaoliang Feng, Wuhan (CN); Jeongwoo Lee, Wuhan (CN)

(21) Appl. No.: 16/300,921

(22) PCT Filed: Sep. 18, 2018
(86) PCT No.: PCT/CN2018/106334

§ 371 Date: Nov. 12, 2018

(30) Foreign Application Priority Data
Apr. 12, 2018 (CN) 201810327895.8

(51) Int. Cl. G06F 3/041; G06F 3/044; G06F 3/047

(52) U.S. Cl. CPC G06F 3/0412; G06F 3/044; G06F 3/047; G02F 1/13338; G06F 2203/04103; G06F 2203/04102; G06F 2203/04111; G06F 2203/04112

(57) ABSTRACT

The invention provides a metal mesh touch display structure. The metal mesh touch display structure includes: a display device and a metal mesh structure; the metal mesh structure includes a bridge point, a first protective layer, first and second metal wires, and a second protection layer; the first and second metal wires are mutually insulated, the first metal wire forms a grid pattern corresponding to the shape of the first direction electrode of mutual capacitance, the second metal wire forms a grid pattern corresponding to the shape of the second direction electrode of mutual capacitance The first protective layer is provided with a via corresponding to the bridge point, and the second metal wire is connected to the bridge point through the via; the grid of the grid pattern is formed on light-shielding layer between the pixels of the display device. The invention also provides a corresponding manufacturing method.

### BACKGROUND OF THE INVENTION

### 1. Field of the Invention

The present invention relates to the field of display, and in particular to a metal mesh touch display structure and manufacturing method thereof.

### 2. The Related Arts

With the development of technology, display technology has become more diversified, and the battle between organic light-emitting diode (OLED) and liquid crystal display (LCD) also represents fierce competition in various technical schools. Especially in the field of mobile phones requiring higher precision, the technical complexity is higher because of the need to mount a touch device. In the current state of the art, because LCD generally requires liquid crystal (LC) to control light, the LCD usually uses hard screen. The OLED, no longer using LC, can be used on flexible substrates as well as hard substrates. Therefore, the OLED is generally considered as the trend of future developments.

Touch technology as a display assistive technology, especially a capacitive touch panel, plays a very important role. The known capacitive touch panel manufacturing technology can be divided into, according to the structure, Out Cell, an On Cell, and In Cell, wherein the Out Cell type further includes Film to Film (FF), Glass to Film (GF), Glass to Glass (GG), One Glass Solution (OGS) and other technologies. With the advancement of technology, the combination of touch and display has become tighter. Major display panel manufacturers have successively developed and promoted On Cell and In Cell technologies, which have become mainstream. Most of the On Cell and In Cell technologies use transparent electrodes as conductive materials, single or multiple layers. In addition to considering touch performance, transmittance and noise treatment must also be considered, which results in less choice of materials (only indium tin oxide (ITO) or transparent nano silver can be used).

At present, the capacitive touch display panels on the market are mainly mutual capacitance type, and the mutual capacitance has the advantage that multi-touch can be realized. The known mutual-capacitive touch screen is generally made of an ITO material on the surface of the glass panel to form a lateral electrode and a longitudinal electrode. A capacitance is formed at where the two electrodes intersect. The lateral coordinate and the longitudinal direction are respectively determined according to the change of the capacitance before and after the touch. Then, the coordinates form the planar touch coordinates.

### SUMMARY OF THE INVENTION

The object of the present invention is to provide a metal mesh touch display structure, to increase the options for the materials usable as touch wires.

Another object of the present invention is to provide a manufacturing method of metal mesh touch display structure, to increase the options for the materials usable as touch wires.

To achieve the above object, the present invention provides a metal mesh touch display structure, which comprises: a display device and a metal mesh structure disposed on the display device; the metal mesh structure comprising a bridge point disposed on the display device, a first protective layer disposed on the bridge point, a first metal wire disposed on the first protective layer for forming a first direction electrode of mutual capacitance and a second metal wire for forming a second direction electrode of the mutual capacitance, formed of a same metal layer, and a second protective layer disposed on the first metal wire and the second metal wire; the first metal wire and the second metal wire being insulated from each other, the first metal wire forming a grid pattern corresponding to shape of the first direction electrodes of the mutual capacitance, the second metal wire forming a grid pattern corresponding to the second direction electrodes of the mutual capacitance; the first protective layer being disposed with a via corresponding to the bridge point, and the second metal wire being connected to the bridge point through the via; grid of the grid patterns being formed on a light-shielding layer between sub-pixels of the display device.

Wherein, the grid size of the grid pattern is substantially equal to or substantially an integer multiple of size of the sub-pixel of the display device.

Wherein, the metal mesh structure further comprises an edge wire and a bonding pad, the edge wire is disposed on an edge of the metal mesh structure, the bonding pad is disposed at one end of the metal mesh structure, and the first metal wire and the second metal wire are respectively connected to the corresponding bonding pads by corresponding edge wires.

Wherein, the bonding pad is connected to an external driving chip providing driving signal.

Wherein, the first metal wire and the second metal wire are designed to have width unrecognizable to naked eyes.

Wherein, the first protective layer is a silicon nitride or organic thin film.

Wherein, the second protective layer is a silicon nitride or organic thin film.

Wherein, the display device is a thin film transistor (TFT)-LCD display panel or an OLED display panel.

Wherein, the display device is a flexible display panel, and the first protective layer and the second protective layer are made of soft materials.

The present invention also provides a manufacturing method of metal mesh touch display structure, which comprises:

Step 10: forming a first metal layer on a display device to form a bridge point;

Step 20: forming a first protective layer on the bridge point;

Step 30: forming a via on the first protective layer at location corresponding to the bridge point;

Step 40: forming a second metal layer on the first protective layer to form a first metal wire and a second metal wire, the second metal wire connected to the bridge point through the via;

Step 50: forming a second protective layer on the first metal wire and the second metal wire.

In summary, the metal mesh touch display structure and the manufacturing method thereof can meet the demand by using conventional widely-used metal materials; the touch is more precise and sensitive, the wires are denser to achieve higher touch resolution. The metal mesh wire is hidden between the sub-pixels without occupying the pixel space and does not affect the display aperture ratio; the double-layer circuit of the bridge point and the metal circuit rely on the via contact, and the contact points are many, which can effectively avoid bad circuit and generate high yield. The present invention can be used in both LCD and OLED processes and can be used for both hard and flexible products.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a cross-sectional view showing the metal mesh touch display structure of a preferred embodiment of the present invention;

FIG. 2 is a top view showing the metal mesh touch display structure of a preferred embodiment of the present invention;

FIG. 3 is a schematic view showing correspondence between sub-pixels and the grid pattern of the metal mesh touch display structure of a preferred embodiment of the present invention;

FIG. 4 is a schematic view showing the sub-pixel location of the metal mesh touch display structure of a preferred embodiment of the present invention;

FIG. 5 is a schematic view showing the metal mesh touch display structure of a preferred embodiment of the present invention applied to a flexible display panel.

### DETAILED DESCRIPTION OF THE PREFERRED EMBODIMENTS

To further explain the technical means and effect of the present invention, the following refers to embodiments and drawings for detailed description.

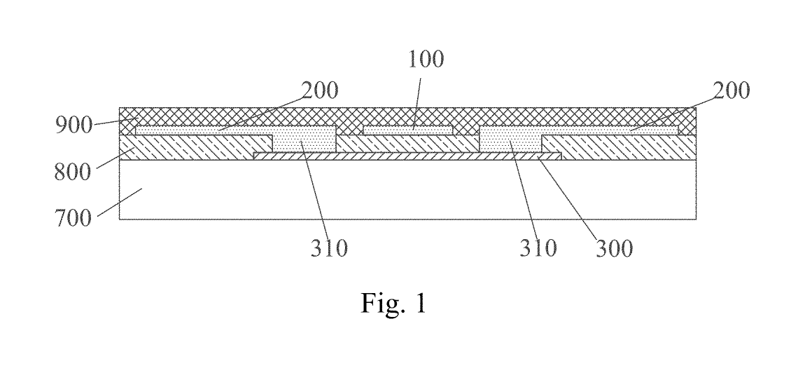

FIG. 1 is a cross-sectional view showing the metal mesh touch display structure of a preferred embodiment of the present invention. The present invention discloses a metal mesh touch display structure, and the structure integrates the touch function and the display function in a monolithic structure and is widely applicable to display panels. The metal mesh touch display structure comprises: a display device 700 and a metal mesh structure disposed on the display device 700; the metal mesh structure comprises a bridge point 300 disposed on the display device 700, a first protective layer 800 disposed on the bridge point 300, a first metal wire 100 disposed on the first protective layer 800 for forming a first direction electrode of mutual capacitance and a second metal wire 200 for forming a second direction electrode of the mutual capacitance, the first metal wire 100 and the second metal wire 200 being formed of a same metal layer, and a second protective layer 900 disposed on the first metal wire 100 and the second metal wire 200. Take a general mutual capacitance as an example, the first direction of the mutual capacitance can be horizontal (X direction) and the second direction can be vertical (Y direction). The first direction electrode and the second direction electrode intersect, specifically, mutually perpendicular. A grid pattern of metal mesh electrodes in the first direction and the second direction of the mutual capacitance may be preset, the first metal wire 100 and the second metal wire 200 are mutually insulated, that is, the electrodes in the two directions of the mutual capacitance must be ensured to be insulated from each other, and the first metal wire 100 forms a grid pattern corresponding to the shape of the first direction electrode of the mutual capacitance, and the second metal wire 200 forms a grid pattern corresponding to the shape of the second direction electrode of the mutual capacitance. The present invention associates the grid distribution with the sub-pixel distribution and fabricates the grid on the light-shielding layer between the sub-pixels of the display device 700. The first protective layer 800 is provided with a via 310 corresponding to the bridge point 300. The second metal wire 200 can communicate with the bridge point 300 through the via 310. The positions of the via 310 and the bridge point 300 can be predetermined according to the shape of the electrodes in two directions of mutual capacitance.

In the preferred embodiment, the bridge point 300 may be disposed between the second metal wires 200 separated by the first metal wire 100 and required to be connected to each other, that is, disposed at the position where the electrodes of two directions of the mutual capacitance staggered. The first protective layer 800 is disposed with a via 310 corresponding to the bridge point 300 and the second metal wire 200 that needs to be connected to each other, so that the second metal wire 200 that needs to be connected to each other can connect through the via 310 and the bridge point 300 while keeping the first metal wire 100 and the second metal wire 200 insulated from each other, thereby avoiding contact in electrode of both directions of mutual capacitance.

The manufacturing process mainly comprises:

Step 10: forming a first metal layer on a display device 700 to form a bridge point 300. The display device 700 may be a TFT-LCD display panel (comprising TFT substrate+CF substrate+LC) or an OLED display panel (comprising TFT substrate+OLED). The first metal layer to from the bridge point 300 is fabricated on the display device 700.

Step 20: forming a first protective layer 800 on the bridge point 300. The first protective layer 800 is fabricated after forming the bridge point 300. The first protective layer 800 may be SiNx or an organic film with insulation and high transmittance.

Step 30: forming a via 310 on the first protective layer 800 at location corresponding to the bridge point 300. The bridge point 300 is exposed by the through hole 310. The location of the via 310 and the bridge point 300 can be determined according to a pre-designed mutual capacitance electrode shape, i.e., a grid pattern; that is, according to the location where the electrodes in the two directions of mutual capacitance are staggered.

Step 40: forming a second metal layer on the first protective layer 800 to form a first metal wire 100 and a second metal wire 200, the second metal wire 200 connected to the bridge point 300 through the via 310. The first metal wire 100 (X-axis direction) and the second metal wire 200 (Y-axis direction) are formed by the second metal layer of metal, wherein the second metal wire 200 is connected to the bridge point 300 through the via 310, thereby first metal wires 100 are in a connected state and the second metal wires 200 are in a connected state according to the grid pattern of the electrodes of the metal mesh of the mutual capacitance.

Step 50: forming a second protective layer 900 on the first metal wire 100 and the second metal wire 200. Finally, the second protective layer 900 is fabricated. This layer can be also made of SiNx or an organic film with certain hardness, insulation function and high transmittance to protect metal wires from scratches and electrostatic breakdown.

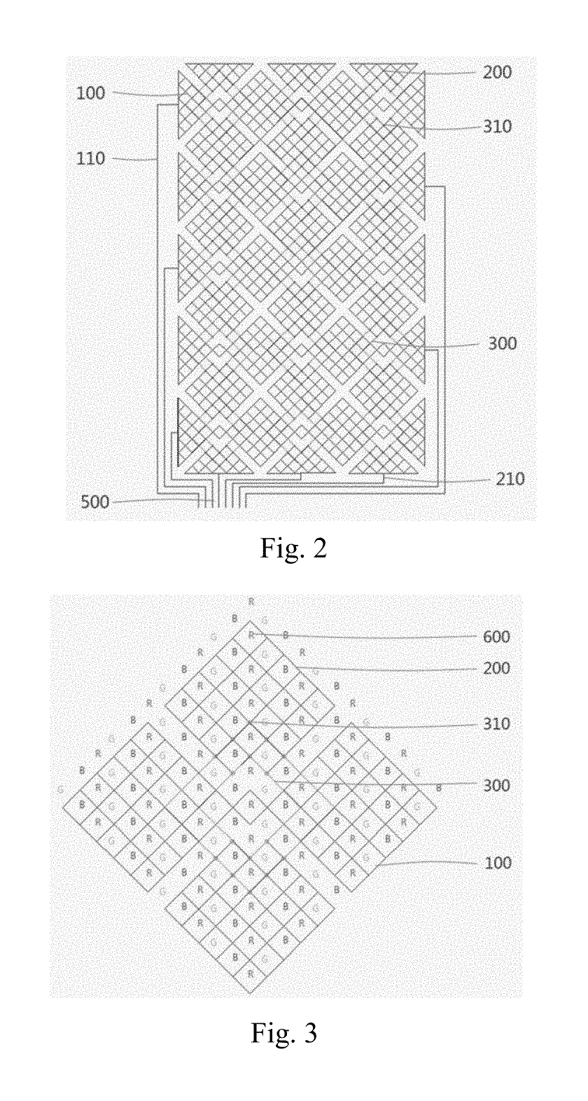

Refer to FIG. 2, which is a top view showing the metal mesh touch display structure of a preferred embodiment of the present invention. Through the distribution of the first metal wires 100, the second metal wires 200, the vias 310 and the bridge points 300, a grid pattern corresponding to the shape of the mutual capacitance lateral electrode and a grid pattern corresponding to the shape of the mutual capacitance longitudinal electrode are formed. The grid pattern formed by the horizontally conducting first metal wires 100 serves as mutual capacitance lateral electrodes, and the grid pattern formed by the second metal wires 200 vertically connected in each row serves as mutual capacitance longitudinal electrodes, each of the mutual capacitance lateral electrodes corresponds to an edge wire 110 disposed at an edge of the metal grid structure, and each of the mutual capacitance longitudinal electrodes corresponds to an edge wire 210 disposed at an edge of the metal mesh structure. The edge wires 110, 210 are connected respectively to bonding pads 500 disposed at one end of the metal mesh structure, thereby drawing from the first metal wires 100 and the second metal wires 200 the pixel areas of the display device of the metal mesh touch display structure and connected to the bonding pad 500, and finally can be connected to the external driving chip through the bonding pad 500 to provide a driving signal for implementing the touch driving.

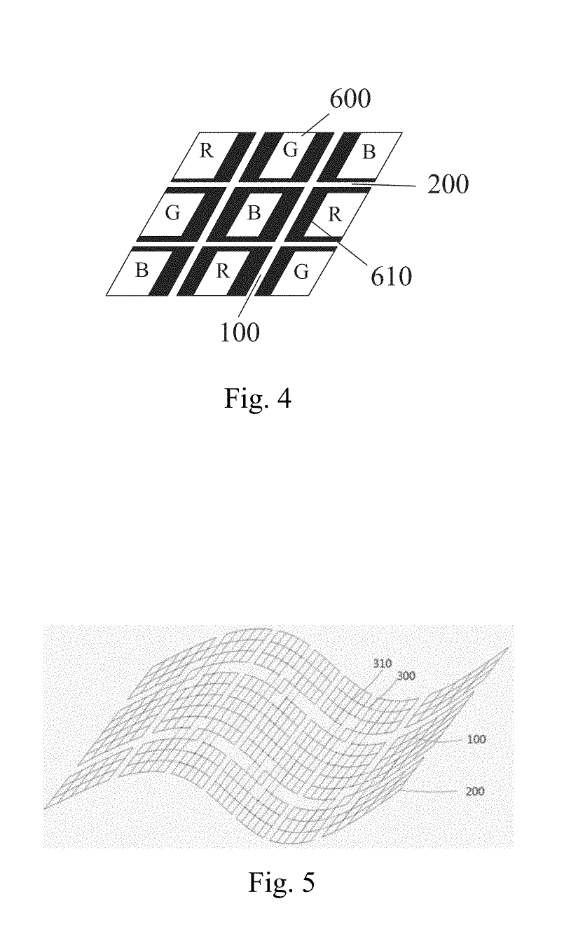

Refer to FIG. 3 and FIG. 4. FIG. 3 is a schematic view showing correspondence between sub-pixels and the grid pattern of the metal mesh touch display structure of a preferred embodiment of the present invention; FIG. 4 is a schematic view showing the sub-pixel location of the metal mesh touch display structure of a preferred embodiment of the present invention. In the grid pattern of the general metal mesh structure, the metal wires are opaque, which may cause the wires to be exposed. In the present invention, the grid of the grid pattern formed by the distribution of the first metal wires 100, the second metal wires 200, the vias 310 and the bridge points 300 is formed on the light-shielding layer 610 between the sub-pixels 600 of the display device. Since the present invention relates the grid distribution to the distribution of the various color (R, G, B) sub-pixels 600, the grid size of the grid pattern may be substantially equal to or substantially equal to an integer multiple size of the sub-pixel 600 of the display device. The present invention can avoid the exposure of the wires by connecting the distribution of the grid wires formed by the metal wires with the distribution of the sub-pixels 600 of the various colors (R, G, B), without affecting the aperture ratio.

The present invention can also choose to design the based on the standard wherein the thickness of the first metal wire 100, the second metal wire 200, and the bridge point 300 to be indistinguishable from the naked eye. By making the metal wire into a finer wire, the unrecognizability to the naked eye can be achieved, so that the metal wire is not seen and the metal wire is eliminated from the sight. The touch is more precise and sensitive, the wires are more detailed, and the touch resolution can be higher.

The invention provides a metal mesh touch display structure and a manufacturing method thereof. By the present invention, a touch circuit is prepared, the choices of material are increased, and different materials and solutions can be designed according to different requirements. The invention can be used in a conventional display panel. In addition, the invention can also be used to make flexible touch solutions, which are suitable for making touch circuit of flexible display panels. FIG. 5 is a schematic view of a preferred embodiment of a metal mesh touch display structure applied to a flexible display panel according to the present invention. Through the distribution of the first metal wires 100, the second metal wires 200, the vias 310 and the bridge points 300, a metal mesh structure corresponding to the shape of the mutual capacitance electrodes in two directions is formed, and is disposed on the flexible display panel, which can change in accordance with the bending of the display panel; at this time, the film structure of the metal mesh structure in FIG. 1 may remain unchanged, but the material may vary, and the first protective layer 800 and the second protective layer 900 tend to be selected from the flexible materials.

In summary, the metal mesh touch display structure and the manufacturing method thereof can meet the demand by using conventional widely-used metal materials; the touch is more precise and sensitive, the wires are denser to achieve higher touch resolution. The metal mesh wire is hidden between the sub-pixels without occupying the pixel space and does not affect the display aperture ratio; the double-layer circuit of the bridge point and the metal circuit rely on the via contact, and the contact points are many, which can effectively avoid bad circuit and generate high yield. The present invention can be used in both LCD and OLED processes and can be used for both hard and flexible products.

It should be noted that in the present disclosure the terms, such as, first, second are only for distinguishing an entity or operation from another entity or operation, and does not imply any specific relation or order between the entities or operations. Also, the terms “comprises”, “include”, and other similar variations, do not exclude the inclusion of other non-listed elements. Without further restrictions, the expression “comprises a . . . ” does not exclude other identical elements from presence besides the listed elements.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claim of the present invention.

What is claimed is:

1. A metal mesh touch display structure, comprising: a display device and a metal mesh structure disposed on the display device; the metal mesh structure comprising a bridge point disposed on the display device, a first protective layer disposed on the bridge point, a first metal wire disposed on the first protective layer for forming a first direction electrode of mutual capacitance and a second metal wire for forming a second direction electrode of the mutual capacitance, formed of a same metal layer, and a second protective layer disposed on the first metal wire and the second metal wire; the first metal wire and the second metal wire being insulated from each other, the first metal wire forming a grid pattern corresponding to shape of the first direction electrodes of the mutual capacitance, the second metal wire forming a grid pattern corresponding to the second direction electrodes of the mutual capacitance; the first protective layer being disposed with a via corresponding to the bridge point, and the second metal wire being connected to the bridge point through the via; grid of the grid patterns being formed on a light-shielding layer between sub-pixels of the display device.
a first via disposed on the color-resist layer for electrically connecting a drain of the TFT and a pixel electrode;
the drain of the TFT comprising a drain body disposed corresponding to the first via, and a first extending portion, a second extending portion, and a third extending portion formed by outwardly protruding from edges of the drain body.

2. The metal mesh touch display structure as claimed in claim 1, wherein the grid size of the grid pattern is substantially equal to or substantially an integer multiple of size of the sub-pixel of the display device.

3. The metal mesh touch display structure as claimed in claim 1, wherein the metal mesh structure further comprises an edge wire and a bonding pad, the edge wire is disposed on an edge of the metal mesh structure, the bonding pad is disposed at one end of the metal mesh structure, and the first metal wire and the second metal wire are respectively connected to the corresponding bonding pads by corresponding edge wires.

4. The metal mesh touch display structure as claimed in claim 3, wherein the bonding pad is connected to an external driving chip providing driving signal.

5. The metal mesh touch display structure as claimed in claim 1, wherein the first metal wire and the second metal wire are designed to have width unrecognizable to naked eyes.

6. The metal mesh touch display structure as claimed in claim 1, wherein the bonding pad is connected to an external driving chip providing driving signal.

7. The metal mesh touch display structure as claimed in claim 1, wherein the second protective layer is a silicon nitride or organic thin film.

8. The metal mesh touch display structure as claimed in claim 1, wherein the display device is a TFT-LCD display panel or an OLED display panel.

9. The metal mesh touch display structure as claimed in claim 1, wherein the display device is a flexible display panel, and the first protective layer and the second protective layer are made of soft materials.

10. A manufacturing method of metal mesh touch display structure as claimed in claim 1, comprising:
Step 10: forming a first metal layer on a display device to form a bridge point;
Step 20: forming a first protective layer on the bridge point;
Step 30: forming a via on the first protective layer at location corresponding to the bridge point;
Step 40: forming a second metal layer on the first protective layer to form a first metal wire and a second metal wire, the second metal wire connected to the bridge point through the via;
Step 50: forming a second protective layer on the first metal wire and the second metal wire.
